(19) United States
(12) Patent Application Publication
(10) Pub. No.: US 2021/0051983 A1
(43) Pub. Date: Feb. 25, 2021

(54) PROCESS FOR PRODUCING PRECOOKED FOOD PRODUCTS

(71) Applicant: Angelo Pietro ROSSIN, VIGEVANO (PV) (IT)

(72) Inventor: Angelo Pietro ROSSIN, VIGEVANO (PV) (IT)

(21) Appl. No.: 16/958,529

(22) PCT Filed: Jan. 14, 2019
(86) PCT No.: PCT/IB2019/050261

§ 371 Date: Jun. 26, 2020

(30) Foreign Application Priority Data
Jan. 16, 2018 (IT) 102018000001110

(51) Int. Cl. A23L 3/02; A23B 4/005; A23L 5/10; A23B 7/005; A23L 3/015

(52) U.S. Cl. CPC A23L 3/02; A23B 4/0056; A23L 5/19; A23B 7/0056; A23L 3/0155; A23L 5/17

(57) ABSTRACT

A process (10) is proposed for producing a precooked food product based on meat, fish, vegetables, fruit, pasta or a sauce. The process (10) comprises: providing (21-27) a packaging containing a food product in a volume insulated from the external environment; extracting (29) air from said volume such that a vacuum condition is created therein; maintaining (31) the packaging at a constant temperature of between 40° C. and 80° C. for a predetermined first time interval, subjecting (35) the packaging to a predetermined pressure of between 250 MPa and 600 MPa for a second time interval less than the first time interval, and bringing (33,37) the packaging to a predetermined temperature of between 0° C. and 4° C. at the end of the first time interval. Further proposed is a precooked food product obtained through the process, its use for the preparation of a gastronomic product and a kit for the preparation of a gastronomic product comprising the said precooked food product.

### TECHNICAL FIELD

The present invention relates to the sector of food products. More particularly, embodiments of the present invention relate to a process for producing precooked food products, the precooked food product obtained through such process and the use thereof in the preparation of a gastronomic product and a kit for the preparation of a gastronomic product comprising the precooked food product.

### PRIOR ART

As is known, precooked food products, in particular in the case of ready meals, have become widespread over the years thanks to their practicality in terms of simplicity of use and storage. However, with the increased attention of consumers towards food products, precooked food products are increasingly associated with a low-quality food image, in particular in food products based on meat or fish, especially due to a perception of the use of raw materials that are not high quality and ample use of preservatives that are added to such products to guarantee a long shelf life.

Despite this, given the persistence of the triggering factors that led to the success of precooked food products, mainly a particularly fast pace of life and, therefore, less time for preparing food - there remains a demand in the consumer food product sector for precooked foods, in particular ready meals, but which are characterised by high quality in terms of the raw materials used and the absence of harmful additives and/or that are perceived in a negative way by consumers.

Futhermore, also in the related catering sector there is a strongly felt need for precooked food products, ready to eat and versatile, in particular adapted to be used in the preparation of various refined gastronomic products extremely quickly in order to guarantee a simple and quick service that can respond to customers' requirements.

Finally, in both of the sectors mentioned above, there is a widely felt need for high quality precooked food products characterised by a long shelf life such as to enable storage for long periods without a reduction in product quality.

An object of the present invention is to overcome the mentioned drawbacks of the prior art, within the context of a simple and rational solution and at a contained cost.

In particular, an object of the present invention is to provide a process adapted for supplying a food product based on meat, fish, vegetables, fruit, pasta or a sauce such as to respond both to the requirements of consumers and restaurateurs.

Such purposes are accomplished by the characteristics of the invention given in the independent claim. The dependent claims outline preferred and/or particularly advantageous aspects of the invention.

### DISCLOSURE OF THE INVENTION

The invention, in particular, provides a process for producing a precooked food product. The process comprises: providing a packaging containing a food product in a volume insulated from the external environment; extracting air from said volume such that a vacuum condition is created therein; maintaining the packaging at a constant temperature of between 40° C. and 80° C. for a predetermined first time interval, subjecting the packaging to a predetermined pressure of between 250 MPa and 600 MPa for a second time interval less than the first time interval.

Thanks to such solution, it is possible to provide a precooked food product quickly, at the same time guaranteeing high health and hygiene conditions for the precooked food product for a particularly long period of time, at least fifty days. Advantageously, the process does not envisage adding any synthetic preservatives to the precooked food product. Furthermore, the process allows the organoleptic properties of the food product to be retained, which are normally dispersed or attenuated through traditional treatment methods.

In one embodiment, the first interval is comprised between 7 minutes and 120 minutes.

In this way, it is possible to guarantee excellent cooking of the meat or fish tissues of the food product, maintaining an extremely contained process duration.

In one embodiment, the second interval of time is comprised between 7 minutes and 30 minutes.

In this way, it is possible to complete the process quickly, without altering the nutritional and organoleptic characteristics of the food product.

In one embodiment, providing a packaging containing a food product comprises: providing a food product containment tray; positioning a portion of a main component of the food product onto the tray, and applying a cover to the containment tray, thereby forming the packaging containing the food product in a volume insulated from the external environment.

Thanks to such solution, the process simply and efficiently provides a particularly practical packaging for treatment, for storage for the final use of the precooked food product.

In one embodiment, the main component of the food product is selected from:
meat;
fish;
vegetables;
fruit,
aromatic herbs, and
cheese.

In this way, it is possible to provide a wide range of high-quality precooked products.

In one embodiment, providing a packaging containing a food product further comprises dosing a dressing preparation on the food product prior to applying the cover.

Thanks to such solution, it is possible to provide a high-quality precooked food product comprising a minimal dressing able to exalt the main component that it accompanies, creating a complete dish that is particularly captivating and ready to eat.

In one embodiment, the dressing preparation comprises a fat component, preferably oily, and an aromatic component.

In this way it is possible to provide a precooked food product, ready to eat, with selected and/or controlled organoleptic characteristics and texture.

In one embodiment, the oily component may be in a quantity comprised between 30% and 90%, more preferably comprised between 40% and 70%, of the mass of the dressing preparation. Preferably, the oily component comprises a vegetable oil such as extra virgin olive oil, olive oil, sunflower oil, peanut oil, grape seed oil, sesame oil or a mixture thereof. For example, the oily component may comprise a mixture of extra virgin olive oil and sunflower oil.

Thanks to such composition a dressing preparation is obtained that ensures the excellent cooking and flavour of the food product.

In one embodiment, the aromatic component is in a quantity comprised between 2% and 15%, more preferably between 4% and 10%, of the mass of the dressing preparation. Preferably, the aromatic component comprises one or more aromatic herbs, e.g. oregano, mint, parsley, savory, thyme, basil and rosemary. More advantageously, the aromatic component comprises a mixture of aromatic herbs in a variable proportion according to the type of food product with which the dressing preparation is associated.

Thanks to such composition, a dressing preparation is obtained that allows higher organoleptic properties to be supplied to the food product through natural ingredients.

In one embodiment, the dressing preparation comprises a quantity of food salt ranging from 5% to 10% of the mass of the dressing preparation. In this way, it is possible to precisely control the flavour of the precooked food product obtained through the process.

In one embodiment, the dressing preparation comprises a quantity of water between 130% and 200% of the weight of the main component.

In this way, optimal hydration of the main component of the product can be assured during cooking, particularly in the case of pasta.

In one embodiment, the dressing preparation comprises at least one additional component selected from:
sugar;
garlic;
pepper;
citrus peel;
onion;
essential oil;
wine;
citric acid;
minced meat, and
minced or blended vegetables.

In this way, the process is particularly versatile and simply adaptable for providing a plurality of food products having a wide range of organoleptic characteristics and aesthetic presentation in batches of variable sizes according to the contingent requirements and market demands.

In one embodiment, the dressing preparation has a pH less than or equal to 6.

In this way, it is possible to guarantee a precooked food product with optimal organoleptic and nutritional characteristics which are maintained unaltered for a long period of time.

In one embodiment, maintaining the packaging at a constant temperature comprises keeping the packaging submerged in a water bath at the constant temperature. Alternatively, the packaging is placed in a saturated chamber of water vapour at the constant temperature.

In this way, a sous-vide cooking process can be performed simply and efficiently.

In one embodiment, the process further comprises bringing the packaging to a predetermined temperature comprised between 0° C. and 4° C. at the end of at least one from among the first time interval and the second time interval.

In this way, an alteration of the food product during and after the treatment thereof is prevented.

A further aspect of the invention relates to the precooked food product obtained according to the method set out above.

In one embodiment, the food product has a water activity a_{w} less than or equal to 0.98 and preferably greater than or equal to 0.88.

Such values of water activity guarantee a high shelf life and substantial inhibition of bacterial growth until the opening of the packaging.

An additional aspect of the invention relates to the use of the food product for the preparation of a gastronomic product comprising at least one additional ingredient selected from among:
minced, pureed or blended vegetables;
vegetable and/or animal fat;
garlic;
onion;
olives;
aromatic herbs, and
spices.

A different aspect of the invention makes available a kit for the preparation of a gastronomic product. Such gastronomic product comprises the food product and a secondary packaging containing a precooked sauce. Preferably, the precooked sauce is obtained by combining two or more of the following ingredients:
minced, pureed or blended vegetables;
vegetable and/or animal fat;
garlic;
onion;
olives;
aromatic herbs, and
spices.

### BRIEF DESCRIPTION OF THE DRAWINGS

Further features and advantages of the invention will be more apparent after reading the following description provided by way of a non-limiting example, with the aid of the figure illustrated in the appended table.

FIG. 1 is a flow diagram of a process for producing a precooked food product according to an embodiment of the present invention.

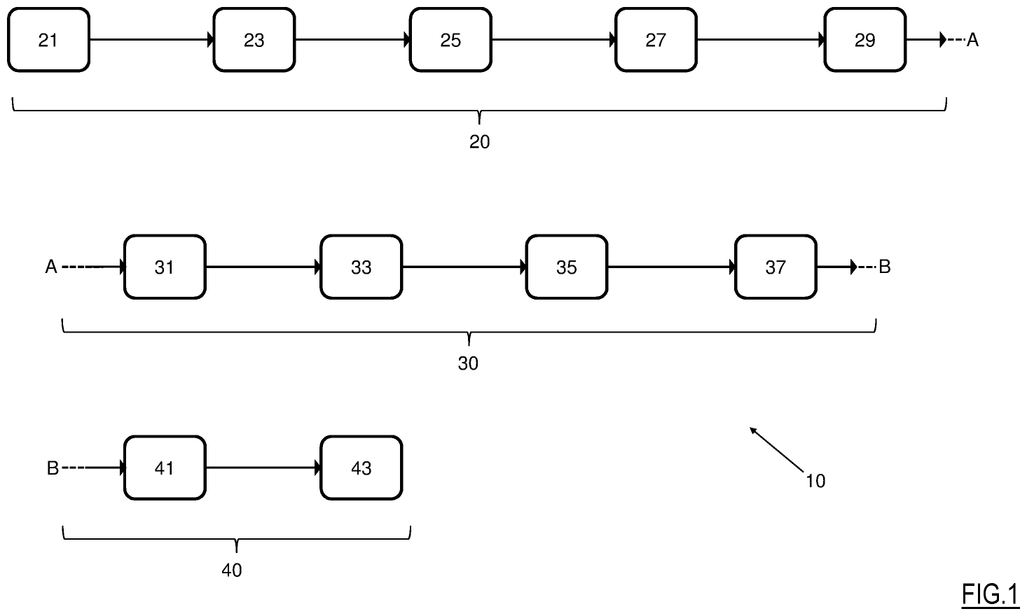

### BEST WAY TO ACTUATE THE INVENTION

Embodiments of the present invention make available a process 10 for producing a precooked food product. A precooked food product relates herein to a portion of food ready to eat and having the characteristics described below.

In a preferred embodiment, the process 10 comprises a plurality of steps that can be grouped into three main sub-processes: packaging 20, cooking 30 and storage 40.

The packaging sub-process 20 provides the packaged food product. In particular, the food product is contained in a packaging comprising a volume insulated from the external environment. Advantageously, the product is packaged in a vacuum condition.

In detail, a first step 21 envisages providing a container, preferably a tray. Advantageously, the containment tray is made of a food contact material that cannot be altered at the process temperatures and pressures specified below. The term ‘cannot be altered’ means herein a material that does not undergo any substantial chemical and/or physical changes; in particular, the material does not react chemically or release any molecular components into a food product with which it comes into contact. Even more preferably, the tray is adapted for use in a microwave oven and/or a normal oven.

In a second step 23, the main component of the food product is arranged on the tray. In particular, the main component of the precooked food product comprises meat, fish, pasta, vegetables or fruit. In other words, the food product is based on meat, fish, pasta, vegetables or fruit. The term ‘main component’ means herein the most significant ingredient of the food product, but not necessarily the ingredient contained in the highest quantity or weight in the food product. Additionally, the food product may consist of a sauce for dressing, or a juice.

In detail, the term ‘meat’ herein follows the definition provided by EC Regulation no. 853/2004 and includes the edible parts of non-aquatic animals (i.e. domestic hoofed animals, poultry, lagomorphs and game). Likewise, also the term ‘fish’ used herein follows the definition of the aforesaid regulation and comprises foods deriving from fishing, i.e. fish and marine or fresh water animals —both wild and farmed—molluscs (e.g. squid, tattler, octopus, cuttlefish, musky octopus), crustaceans (e.g. prawns, scampi, crayfish, lobster, crab, spider crab and mantis shrimp) and all the edible forms, parts and products of such living creatures generally called ‘seafood’. In one embodiment, the food product comprises a portion, indicated as cut or slice, of meat or fish with a weight comprised between 50 g and 800 g, more preferably comprised between 100 g and 500 g.

Alternatively, the food product may comprise a portion of pasta, also indicated by the term ‘food pasta’. In particular, the pasta may be of the dry or fresh type and, in the latter case, may comprise a filling. In one embodiment, the food product comprises a portion of pasta with a weight comprised between 50 g and 800 g, more preferably comprised between 80 g and 200 g.

Also alternatively, the food product can comprise a portion of one or more vegetables. For example, in a non-limiting way, the food product may comprise one or more from among broccoli, cabbage, carrots, aubergines, peppers, savoy, pumpkin and/or courgettes. In one embodiment, the food product comprises a portion of vegetables with a weight comprised between 50 g and 800 g, more preferably comprised between 80 g and 200 g.

According to another alternative, the food product can comprise a portion of one or more fruits. For example, in a non-limiting way, the food product may comprise one or more from citrus fruits, berries, bananas, apples and/or pears. In one embodiment, the food product comprises a portion of fruit with a weight comprised between 50 g and 800 g, more preferably comprised between 80 g and 200 g.

Finally, the food product can comprise a portion of sauce, or juice, to accompany meat, fish and/or pasta. For example, in a non-limiting way, the food product can comprise a sauce based on tomato, aromatic herbs and/or cheese. In one embodiment, the food product comprises a portion of tomato, aromatic herbs or cheese with a weight comprised between 50 g and 800 g, more preferably comprised between 50 g and 100 g.

Preferably, the process 10 comprises a third step 25 in which a dressing preparation is dosed onto the main component of the food product arranged on the tray.

In a preferred embodiment, the dressing preparation comprises an oily component and an aromatic component. The oily component may be in a quantity comprised between 30% and 90%, more preferably comprised between 40% and 70%, of the mass of the dressing preparation. Preferably, the oily component comprises a vegetable oil such as extra virgin olive oil, olive oil, sunflower oil, peanut oil, grape seed oil, sesame oil or a mixture thereof. For example, the oily component may comprise a mixture of extra virgin olive oil and sunflower oil. The aromatic component is in a quantity comprised between 2% and 15%, more preferably between 4% and 10%, of the mass of the dressing preparation. Preferably, the aromatic component comprises one or more aromatic herbs, e.g. oregano, mint, parsley, savory, thyme, basil and rosemary. Advantageously, the aromatic component comprises a mixture of aromatic herbs in a variable proportion according to the type of the main component of the food product with which the dressing preparation is associated.

Furthermore, the dressing preparation preferably comprises a quantity of food salt comprised between 2% and 15%, more preferably between 5% and 10%, of the mass of the dressing preparation.

Advantageously, according to the type of the main component of the food product, the dressing preparation can comprise at least one additional component selected from:
sugar between 4% and 10%, more preferably between 6% and 8%, of the mass of the dressing preparation;
garlic between 0.1% and 0.8%, more preferably between 0.3% and 0.5%, of the mass of the dressing preparation;
pepper between 0.1% and 0.3% of the mass of the dressing preparation;
citrus peel between 1% and 2% of the mass of the dressing preparation;
red onion between 0.1% and 0.5% of the mass of the dressing preparation;
essential oil, e.g. of citrus fruits, in a quantity less than 0.1% of the mass of the dressing preparation,
wine between 1% and 2% of the mass of the dressing preparation, and
citric acid between 0.1% and 0.2% of the mass of the dressing preparation.

Alternatively or additionally, in the case of preparing food products based on pasta or sauces, the dressing preparation can comprise at least one additional component selected from:
minced and/or ground meat, and
blended and/or minced vegetables.

The specific composition of the dressing preparation is calibrated based on the type of main component of the food product and the desired organoleptic/aromatic result.

Regardless of the specific composition, the dressing preparation preferably has a pH less than or equal to 6.

In the case of a pasta-based food product, the dressing preparation can comprise a quantity of water comprised between 130% and 200%, preferably comprised between 130% and 160%, of the weight, or mass, of the pasta to allow optimal hydration of the pasta during cooking. Alternatively, the pasta-based food product can be provided with a ratio between pasta—i.e. the main component—and dressing preparation comprised between 1:1 and 1:3, preferably between 1:1 and 1:2.5 to guarantee optimal hydration of the pasta during cooking.

Subsequently, a fourth step 27 envisages arranging a cover, e.g. a film, on the tray, so as to define a volume containing the food product. The film is fixed to the tray, e.g. heat sealed, thus defining a packaging in which the food product is contained, insulated from the external environment. The film is made of food contact material, preferably that cannot be altered at the process temperatures and pressures 10 specified below.

A fifth step 29, which concludes the packaging sub-process 20, envisages removing the air contained in the volume defined by the tray and film, therefore maintaining the food product in a vacuum condition. Preferably, the film adheres substantially to the food product on the tray and to the surrounding surface thereof. In other words, a packaging also known as ‘skin’ in technical jargon is obtained. Advantageously, the film adheres to the food product without any tensions and substantially without altering the shape of the food product itself.

Preferably, the fifth step 29 is performed simultaneously with the fourth step 27. In other words, the application of the cover and the creation of vacuum are performed through a single operation.

Once the packaging 20 has been finished, the food product comprises the main component and the dressing preparation is completely packaged.

The packaged food product is then subjected to the cooking sub-process 30. In the preferred embodiment, the cooking sub-process 30 subjects the already packaged food product to a cooking treatment. In particular, the cooking sub-process 30 uses a sous-vide type cooking process according to a particularly quick method, but that can at the same time guarantee a hygienically healthy and safe food product.

In a sixth step 31 of the process 10, the packaged food product is maintained at a constant temperature T_{c} comprised between 40° C. and 80° C., more preferably comprised between 45° C. and 75° C., for a time interval t₁ comprised between 7 min. and 120 min., more preferably comprised between 10 min. and 90 min. Advantageously, the specific values of the constant temperature T_{c} and of the time interval t₁ are determined based on the type of food product (i.e. meat or fish and/or type of cut), its size (e.g. the volume) and/or its weight (or mass).

In one embodiment, the packaged food product is immersed in a water bath at the constant temperature T_{c} for the duration of the time interval t₁. In one alternative embodiment, the packaged food product is placed in a saturated chamber of water vapour at the constant temperature T_{c} for the duration of the time interval t₁.

Step 31 therefore performs the cooking of the product in vacuum or sousvide conditions, with a reduced time scale with respect to the prior art, in which cooking for a high duration is recommended, e.g. a duration that ranges from a few hours to much longer periods, e.g. forty-eight hours.

Preferably, although in a non-limiting way, the process 10 comprises a seventh step 33, or a rapid chilling step, in which the temperature of the packaged food product is reduced within an interval comprised between 0° C. and 4° C.

In a subsequent eighth step 35, the packaged food product is subjected to a predetermined pressure P comprised between 250 MPa (2.5 Kbar) and 600 MPa (6 Kbar), preferably comprised between 400 MPa (4 Kbar) and 600 MPa (6 Kbar), for a second interval of time t₂. In one embodiment, the second interval of time t₂ has a duration comprised between 5 min. and 20 min., more preferably comprised between 7 min. and 15 min. Also in this case, the specific pressure P and time interval t₂ values are determined based on the type of the main component of the food product (i.e. meat or fish and/or type of cut thereof, pasta, vegetables, fruit or base of the sauce) the size thereof (e.g. the volume) and/or the weight (or mass) thereof. Additionally, the specific pressure P and time interval t₂ values can also be determined based on the constant temperature T_{c} and/or the duration of the first time interval t₁ of step 31. For example, the selected second time interval t₂ is preferably less than the first time interval t₁.

In one embodiment, in order to subject the packaged food product to the pre-determined pressure P, it is introduced into a chamber that is filled with a fluid, e.g. water. The pressure inside the chamber is increased through a system of pumps, e.g. piston pumps. Advantageously, the fluid transmits the pressure in a uniform way to the packaged food product. Subsequently, the chamber is depressurised and the food product is removed to be subjected to the subsequent steps of the process 10.

The combination of rapid sous-vide type cooking and the high-pressure treatment allows complete and uniform cooking of the food product to be obtained quickly, hence allowing quick production of the precooked food product, at the same time, guaranteeing the full health and hygiene thereof. Advantageously, such combination of rapid sous-vide cooking and high-pressure treatment allows the nutritional factors present in the food product to be kept unaltered. Additionally, the rapid sous-vide cooking type and the high-pressure treatment has the surprising result of guaranteeing excellent amalgamation between the main component of the food product and the dressing preparation. In particular, the organoleptic characteristics both of the main component and of the aromatic component comprised in the food product are intact at the end of the cooking sub-process 30 making the pre-cooked food product obtained through the process 10 extremely high quality. Furthermore, the combination of sous-vide type cooking and high-pressure treatment allows very long shelf life periods of the precooked food product to be reached during which the nutritional and organoleptic characteristics thereof are maintained substantially unaltered. In particular, such a long shelf life is reached without the need to add any preservatives to the food product.

At this point of the process 10, the food product is cooked, therefore it is indicated as a precooked food product below—and is ready for storage and/or use.

The cooking sub-process 30 preferably comprises a ninth step 37, or a rapid chilling step, in which the temperature of the precooked food product is reduced within an interval comprised between 0° C. and 4° C.

In the preferred embodiment, the storage sub-process 40 envisages completing the packaging of the precooked food product and the storage thereof for distribution.

Preferably, the process 10 comprises a tenth step 41 in which one or more labels—e.g. bearing information on ingredients, nutritional values and/or indications for use—can be applied on an outer surface of the packaging and/or the precooked food product can be boxed or wrapped.

Finally, in an eleventh step 43 the precooked food product is stored at a con- trolled storage temperature, e.g. comprised between 0° C. and 4° C. and is ready for distribution.

It is observed how the process 10 according to embodiments of the present invention guarantees particularly high hygiene standards as the food product is insulated from the external environment in the initial steps of the process—in sub-process 20—and is therefore processed when completely packaged without any possibility of direct contact with people, machinery, foreign bodies or process substances, until the casing is opened by the final user. Additionally, the process 10 allows production scraps or waste to be substantially eliminated.

The precooked food product provided by the process according to the present invention has an extremely long shelf life, greater than 30 days, in particular greater than or equal to 50 days, keeping intact its organoleptic and quality characteristics. Analyses performed by the Applicant highlighted that the precooked food product made available by the process of the present invention is characterised by a water activity less than or equal to 0.98, and preferably greater than or equal to 0.88.

The precooked food product is ready to use, i.e. to eat. Preferably, the pre-cooked food product can be heated in a microwave oven or in a traditional oven directly in the packaging, even more preferably after the covering film has been pierced or removed. Naturally, there is nothing to stop the pre-cooked food product being brought to presentation temperature by heating it on a hob, for example in a frying pan, once removed from the packaging.

The precooked food product according to the present invention therefore responds to the need felt on the ready meal market of high quality, ready for substantially immediate consumption, and characterised by the possibility to be stored for extended periods of time.

In particular, the food product obtained through the process 10 responds to the need that is felt both in the catering sector and in the large-scale retail sector to have high quality precooked food products available adapted to be quickly presentable to customers for consumption or for purchase and easy to store for extended periods of time, thus allowing a simplification of the stock and supply management operations thereof.

Furthermore, the dressing preparation that accompanies the food product—and with which the latter is cooked—provides an aesthetic presentation element of the product that is particularly captivating for the final user, in addition to the primary function of seasoning and enriching the food product.

Additionally, the precooked food product according to embodiments of the present invention is suitable for use in the preparation of one or more gastronomic products. In particular, the precooked food product can constitute a main component of a gastronomic product.

For example, a gastronomic product can comprise the precooked food product and one or more of the following additional ingredients:
additional ingredient selected from among:
minced, pureed or blended vegetables.
vegetable and/or animal fat;
garlic;
onion;
olives;
aromatic herbs, and
spices.

In detail, the additional ingredients may be combined with each other separately and, subsequently, added to the precooked food product. In one embodiment, the additional ingredients can be combined to make a sauce available.

For example, it is possible to make a sauce, particularly adapted for a pre-cooked food product comprising fish, e.g. a cut of fish comprised between 100 g and 200 g, by combining and cooking the following additional ingredients:
crushed tomatoes 150 g;
olive oil 20 g;
garlic and onion 10 g;
about 7 green olives, and
aromatic herbs (preferably parsley and basil) about ⅔ g.

Then the precooked food product is added to the sauce thus obtained, i.e. the cut of fish and the dressing preparation in the example considered, to obtain the desired gastronomic product.

Alternatively, the precooked food product and the additional ingredients may be combined directly together.

Advantageously, before being added to the sauce, the food product can be preheated in one of the following ways:
in a 750 W microwave for about 2/4 min.;
in an oven at 165° C. for about 10/12 min.; or
in a frying pan on the hob (or other analogous heat source) for about 5/7 min.

One embodiment of the present invention envisages providing a kit for preparing a gastronomic product. The kit comprises the precooked food product and a precooked accompanying sauce. Preferably the accompanying sauce is contained in a separate packaging from the precooked food product. Even more preferably, the accompanying sauce is made through the method 10 according to embodiments of the present invention. In other words, the accompanying sauce is a further precooked food product. However, there is nothing to stop the provision of a kit comprising an accompanying sauce made according to a different method.

Advantageously, the precooked food product and the accompanying sauce a grouped into an overall packaging. For example, the precooked food product and the accompanying sauce are boxed together in a common container. For that purpose, the storage sub-process 40, described above, may comprise an additional step, downstream of step 41, wherein the precooked food product and a secondary packaging containing the accompanying sauce are boxed in a common packaging before the storage step 43.

The invention thus conceived can undergo numerous modifications and variants all of which are covered by the inventive concept.

In particular, the process 10 described above can be performed in a production line that envisages the preparation of a plurality, i.e. a batch, of food products precooked in parallel. Additionally, thanks to the isolation of the food products guaranteed by the packaging there is nothing to stop the cooking sub-process 30 being implemented in parallel for different types of food product.

Furthermore, all the details can be replaced with other technically equivalent elements and the process can comprise additional steps or some steps of the process can be performed in parallel. For example, the process can comprise one or more steps intended to provide the dressing preparation made previously or in parallel to the first two steps 21 and 23 of the packaging sub-process 20, so as to make available the dressing preparation in the third step 25 of the packaging sub-process 20.

Furthermore, there is nothing to stop the provision of a precooked food product comprising only the main component and a predetermined quantity of water, such as for example a cut of ‘plain’ meat or fish, or a portion of ‘plain’ pasta.

In practice, any materials can be used according to the requirements without for this reason departing from the scope of protection of the following claims.

1. A process (10) for producing precooked food products comprising:
providing (21-27) a packaging containing a food product in a volume insulated from the external environment;
extracting (29) air from said volume such that a vacuum condition is created therein;
maintaining (31) the packaging at a constant temperature of between 40° C. and 80° C. for a predetermined first time interval,
subjecting (35) the packaging to a predetermined pressure of between 250 MPa and 600 MPa for a second time interval of less than the first time interval, and
bringing (33, 37) the packaging to a predetermined temperature of between 0° C. and 4° C. at the end of the first time interval.

2. The process (10) according to claim 1, wherein the first interval is comprised between 7 minutes and 120 minutes.

3. The process (10) according to claim 1 or 2, wherein the second time interval is comprised between 7 minutes and 30 minutes.

4. The process (10) according to any one of the preceding claims, wherein providing (21-27) a packaging containing a food product comprises:
providing (21) a food product containment tray;
positioning (23) a portion of a main component of the food product onto the tray, and
applying (27) a cover to the containment tray, thereby forming the packaging containing the food product in a volume insulated from the external environment.

5. The process according to claim 4, wherein the main component of the food product is selected from among:
meat;
fish;
vegetables;
fruit,
aromatic herbs, and
cheese.

6. The process (10) according to claim 4 or 5, wherein providing (21-27) a packaging containing a food product further comprises:
dosing (25) a dressing preparation on the food product prior to applying the cover, the dressing preparation comprising an oily component and an aromatic component.

7. The process (10) according to claim 6, wherein the dressing preparation comprises a quantity of food salt ranging from 5% to 10% of the mass of the dressing preparation.

8. The process (10) according to claim 6 or 7, wherein the dressing preparation comprises a quantity of water of between 130% and 200% of the weight of the main component.

9. The process (10) according to any one of claims 6 to 8, wherein the dressing preparation comprises at least one additional component selected from among:
sugar;
garlic;
pepper;
citrus peel;
onion;
essential oil;
wine;
citric acid;
minced meat, and
minced, pureed or blended vegetables.

10. The process (10) according to any one of the preceding claims 6 to 9, the dressing preparation having a pH less than or equal to 6.

11. The process (10) according to any one of the preceding claims, further comprising:
bringing (33, 37) the packaging to a predetermined temperature of between 0° C. and 4° C. at the end of the second time interval.

12. Precooked food product obtained through the process (10) according to any one of the preceding claims, the precooked food product comprising a dressing preparation comprising a quantity of food salt ranging from 5% to 10% of the mass of the dressing preparation.

13. The precooked food product according to claim 12, having a water activity greater than, or equal to, 0.88.

14. Use of the precooked food product according to claim 12 or 13 for the preparation of a gastronomic product comprising at least one additional ingredient selected from among:
minced, pureed or blended vegetables;
vegetable and/or animal fat;
garlic;
onion;
olives;
aromatic herbs, and
spices.

15. Kit for the preparation of a gastronomic product comprising the food product according to claim 12 or 13 and a secondary packaging containing a precooked sauce obtained by combining two or more of the following ingredients:
minced, pureed or blended vegetables;
vegetable and/or animal fat;
garlic;
onion;
olives;
aromatic herbs, and
spices.
